(19) United States
(12) Patent Application Publication
(10) Pub. No.: US 2024/0250958 A1
(43) Pub. Date: Jul. 25, 2024

(54) HYBRID MESSAGE PASSING NEURAL NETWORK AND PERSONALIZED PAGE RANKING GRAPH CONVOLUTION NETWORK MODEL

(71) Applicant: GOOGLE LLC, Mountain View, CA (US)

(72) Inventors: Amitabha Roy, Kitchener (CA); Nasrin Baratalipour, Kitchener (CA); Vinit Jogani, Kitchener (CA); Pushkarini Agharkar, Kitchener (CA)

(21) Appl. No.: 18/014,287

(22) PCT Filed: Dec. 27, 2021
(86) PCT No.: PCT/US21/65211

§ 371 Date: Jan. 3, 2023

(51) Int. Cl. H04L 9/40; G06N 3/0464

(52) U.S. Cl. CPC H04L 63/14; G06N 3/0464

(57) ABSTRACT

A method and system for classifying assets by features of individual entities and relations of the individual entities to the assets using a neural network is disclosed herein. The method comprises aggregating, at each of a plurality of aggregator nodes, data regarding features of each node in each distant neighborhood of a multiplicity of distant neighborhoods; updating, at each of the plurality of aggregator nodes, a state of the aggregator node by assigning a weight to each of the features of the corresponding distant neighborhood; updating, at the seed node, a state of the seed node by performing convolutional analysis of each node in a local neighborhood surrounding the seed node; and determining a label of the seed node based on the state of the seed node.

### FIELD OF THE DISCLOSURE

This disclosure relates to neural network processing, more particularly, to analyzing characteristics of a site using a hybrid message passing neural network and graph convolution network model.

### BACKGROUND

Present techniques for analyzing large and distant-reaching neural networks, such as message passing neural networks (MPNNs), require deep neural networks with recurrent blocks for even simple message schedules. Because learning degrades with the size of a subgraph and the recurrence of blocks in the network, present techniques lead to over-smoothing in that different nodes appear similar or identical. Further, the use of conventional techniques to analyze large neural networks requires long computation times and heavy power requirements. As such, new techniques for analyzing neural networks are desired.

### SUMMARY

A system maintains a network of nodes and edges, each node representing an asset that corresponds to a content source, such as a website or domain. The network of nodes includes a central seed node being analyzed, as well as one or more distant neighborhoods. Each distant neighborhood includes an aggregator node that aggregates and weights data regarding features of each node in the corresponding neighborhood using a linear weighting method.

The seed node performs convolutional analysis for a local neighborhood including each of the aggregator nodes. Based on the output of the convolutional analysis, the system then classifies and labels the seed node and the asset and/or content source associated with the seed node.

One example embodiment of these techniques is a method for classifying assets by features of individual entities and relations of the individual entities to the assets using a neural network configured to maintain a network of nodes including a plurality of nodes and edges, each node of the plurality of nodes representing a respective asset of a plurality of assets corresponding to a plurality of content sources. The method includes: aggregating, by the one or more processors and at each of a plurality of aggregator nodes in the network of nodes, data regarding features of each node in each distant neighborhood of a multiplicity of distant neighborhoods, wherein each distant neighborhood corresponds with an aggregator node of the plurality of aggregator nodes, a neighborhood is a subset of nodes surrounding the aggregator node within a predefined distance, and a distant neighborhood is a neighborhood of nodes separated from a seed node of the plurality of nodes by at least two intermediate nodes; updating, by the one or more processors and at each of the plurality of aggregator nodes, a state of the aggregator node by assigning a weight to each of the features of the corresponding distant neighborhood; updating, by the one or more processors and at the seed node, a state of the seed node by performing convolutional analysis of each node in a local neighborhood surrounding the seed node, the local neighborhood including each of the plurality of aggregator nodes; and determining, by the one or more processors, a label of the seed node based on the state of the seed node.

Another example embodiment of these techniques is a system comprising processing hardware and a memory storing computer-executable instructions, the system configured to implement the method above.

### BRIEF DESCRIPTION OF THE DRAWINGS

FIG. 1A is a block diagram of an example system in which a neural network comprising a plurality of network nodes performs machine learning using hybrid message passing neural network and personalized page ranking (MPNN-PPR) graph convolution techniques;

FIG. 1B is a block diagram of the architecture of a computer system upon which one or more network nodes may operate;

FIG. 2 illustrates an example network of nodes including local node neighborhoods, aggregator nodes, and a seed node, which may be implemented in the system and device of FIGS. 1A-1B;

FIG. 3 is a block diagram of an example neural network, implementing the hybrid MPNN-PPR graph convolution techniques to label a seed node;

FIG. 4A is a block diagram of an example neural network implementing a message passing schedule to label a seed node;

FIG. 4B illustrates a message passing schedule to be implemented in the example neural networks of FIGS. 3 and 4A; and

FIG. 5 is a flow diagram of an example method for performing hybrid MPNN-PPR graph convolution to determine a label for a seed node by aggregating data for node neighborhoods at aggregator nodes and performing convolution at the aggregator nodes, implemented on the neural network of FIG. 3.

### DETAILED DESCRIPTION

A data processing server, client devices, content provider devices, and/or publisher devices implement the techniques of this disclosure to implement and maintain a hybrid message passing neural network and personalized page ranking (PPR) graph convolution network. The data processing server uses the hybrid neural network to analyze an asset such as a website tied to a seed node and determines whether to label the asset as being potentially malicious and/or dangerous based on the analysis.

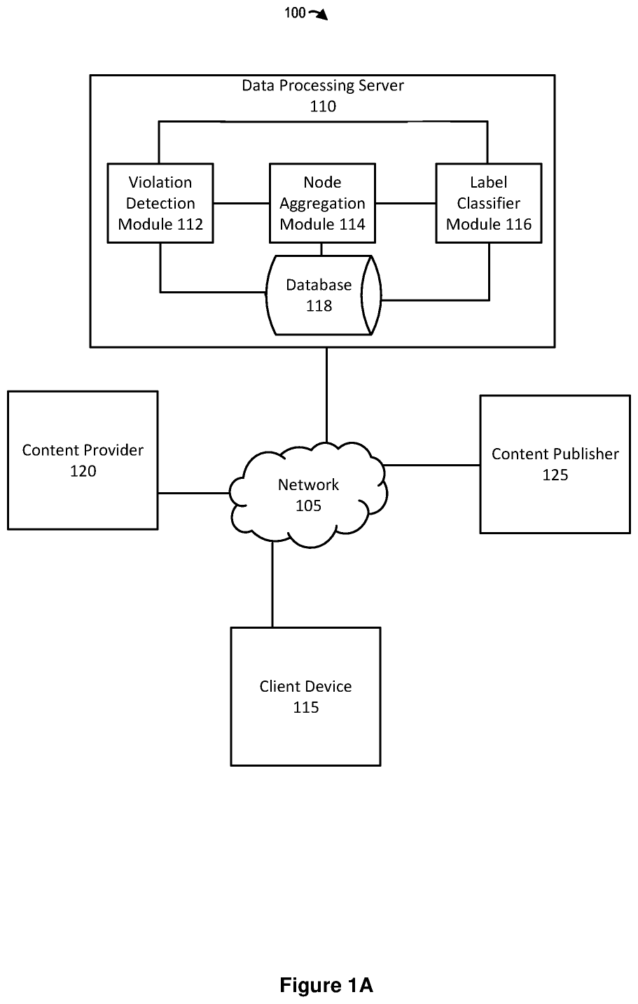

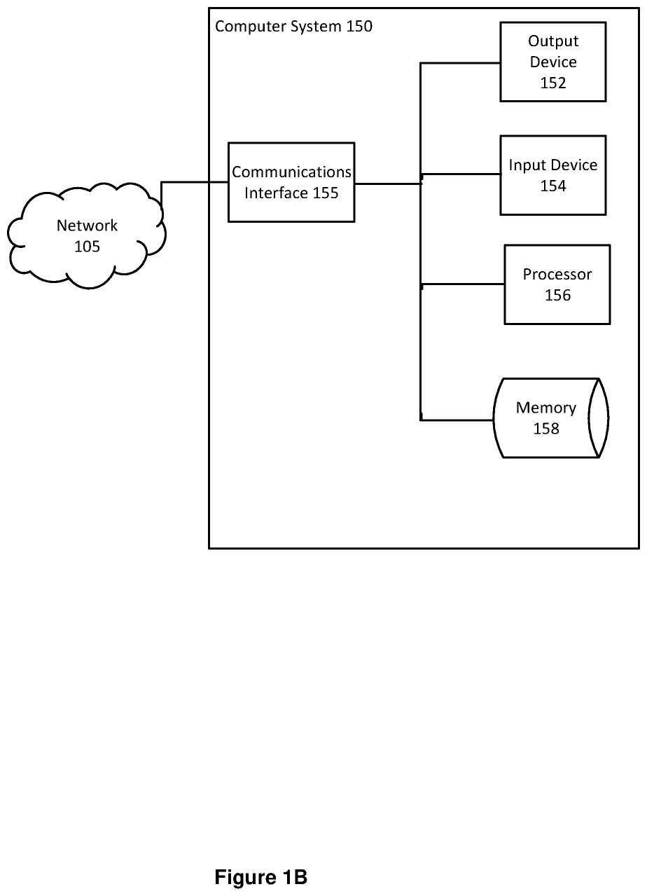

In particular, referring first to FIG. 1A, an example content labelling system 100 for maintaining the integrity of content distribution among multiple computing devices includes a data processing server 110, a client device 115, a content provider 120, and a content publisher 125, all communicatively coupled via a network 105. In some implementations, the data processing server 110 may include a database 118 and a number of logic modules, such as a violation detection module 112, a node aggregation module 114, and a label classifier module 116.

The data processing server 110 includes at least one processor and a memory. The memory stores computer-executable instructions that, when executed by the processor, cause the processor to perform one or more of the operations described herein. Depending on the implementation, the processor(s) may include any of a microprocessor, application-specific integrated circuit (ASIC), field-programmable gate array (FPGA), etc., or combinations thereof. Similarly, the memory can include any of electronic, optical, magnetic, or any other storage or transmission device capable of providing the processor with program instructions. The memory can further include any or all of a floppy disk, CD-ROM, DVD, magnetic disk, memory chip, ASIC, FPGA, read-only memory (ROM), random-access memory (RAM), electrically-erasable ROM (EEPROM), erasable-programmable ROM (EPROM), flash memory, optical media, or any other suitable memory from which the processor can read instructions. The instructions can include code from any suitable computer-programming language. Though not illustrated in FIG. 1A, the data processing server 110 can include and/or is communicatively coupled to one or more computing devices or servers that can perform various functions.

The network 105 can be and/or include computer networks such as the Internet, a local area network (LAN), a wide area network (WAN), a metropolitan area network, one or more intranets, a satellite network, a cellular network, an optical network, other types of data network, or a combination thereof. The data processing server 110 is capable of communicating via the network 105 with the one or more content provider computing devices 115, the one or more content publisher computing devices 120, or the one or more client devices 125. The network 105 can include any number of network devices, such as gateways, switches, routers, modems, repeaters, and wireless access points, among others. The network 105 can also include computing devices such as computer servers. The network 105 can also include any number of hardwired and/or wireless connections.

The one or more content provider computing devices 115 are and/or include computer servers, personal computers, handheld devices, smart phones, or other computing devices operated by a content provider entity, such as an advertiser or an agent thereof. The one or more content provider computing devices 115 can provide content, such as textual content, image content, video content, animation content, software program content, content items, and/or uniform resource locators among other types of content, to the data processing server 110 for display on information resources. Specifically, the one or more content provider computing devices 115 of a given content provider can be the source of content items or content used to generate content items of that content provider. The content items can be for display in information resources rendered on client devices 125, such as websites, webpages of search results, client applications, gaming applications or platforms, open source content sharing platforms, or social media platforms, among others.

The data processing server 110 can provide one or more interfaces accessible via the content provider computing devices 115 to allow content provider entities, for example, to generate respective content provider accounts, or generate respective campaigns. The user interface(s) can allow content provider entities to upload respective content to the data processing server 110 or other remote systems, or provide respective payment information. In general, the user interface(s) can allow each content provider entity to indicate respective assets used for distribution of content of that entity to client devices 125. As used herein, assets of a content provider entity can include content provider accounts, content distribution campaigns, payment information, domain names, hosts, websites or webpages including landing pages, content items (e.g., software programs, images, video segments, text, animation segments, etc.), or resources accessible from the websites, domains, or hosts among other assets of the content provider.

The content publisher computing device 120 can include servers or other computing devices operated by a content publishing entity to provide primary content for display via the network 105. The primary content can include websites, webpages, client applications, gaming content, or social media content among others for display on the client devices 125. The primary content can include search results provided by search engines. Pages, video segments, or other units of the primary content can include executable instructions, such as instructions associated with content (or ad) slots that cause the client device 125 to request third-party content from the data processing server 110 or other remote systems when the primary content is displayed on the client device.

The client device 125 can include a computing device configured to acquire and display primary content provided by the content publisher computing device 120 as well as content (e.g., third-party content items such as texts, software programs, images, and/or videos) provided by the content provider computing device 115. The client device can request and receive such content via the network 105. The client device 125 can include a desktop computer, laptop computer, tablet device, smartphone, personal digital assistant, mobile device, consumer computing device, server, digital video recorder, set-top box, smart television, video game console, or any other computing device capable of communicating via the network 105 and consuming media content. While FIG. 1A shows a single client device 125, the system 100 can include multiple client devices 125 that the data processing server 110 serves.

In some implementations, while users of the client devices 125 can select which primary content to access, the client devices do not have much control over the content provided by the content provider computing devices 115 because the data processing server 110 selects such content automatically. Third-party content providers or the respective content provider computing devices 115 can expose the client devices 125 to inappropriate or undesired content, data privacy violations, or cybersecurity threats among other risks. To protect client devices 125 from such risks and maintain the integrity of third-party content distribution, the data processing server 110 can set policies by which third-party content in providers and/or respective content provider computing devices 115 are to abide. The data processing server 110 can also employ mechanisms to enforce the policies, for example, by detecting violations of the policies or labels associated with the policies and preventing distribution of content associated with policy violators or some policy labels. Once a policy violation or policy label associated with an asset is detected, the data processing server 110 can identify all assets associated with the source of policy violation or the source of assets associated with the policy label. The data processing server 110 can then tag such assets, for example, as malicious, suspicious, and/or blocked.

The data processing server 110 can include a third-party content placement system, e.g., an ad server or ad placement system. The data processing server 110 further includes a number of logic modules. In some such implementations, the data processing server 110 includes a violation detection module 112, a node aggregation module 114, a label classifier module 116, and a database 118. Depending on the implementation, each of the violation detection module 112, node aggregation module 114, and label classifier module 116 can be implemented as a software module, hardware module, or a combination of both. For example, each of these modules can include a processing unit, server, virtual server, circuit, engine, agent, appliance, or other logic device such as programmable logic arrays configured to communicate with the database 118 and/or with other computing devices via the network 105. The computer-executable instructions of the data processing server 110 can include instructions, which, when executed by one or more processors, cause the data processing server 110 to perform operations discussed below with regard to the violation detection module 112, node aggregation module 114, and label classifier module 116, or a combination thereof.

The database 118 can maintain a network of nodes that includes a plurality of nodes and edges connecting respective pairs of nodes. Each node of the plurality of nodes can represent a corresponding asset among a plurality of assets of a plurality of content providers or content sources. The database can maintain the network of nodes using one or more data structures, such as a tree, a linked list, a table, a string, or a combination thereof. The database can use the network of nodes (or the one or more data structures) to keep track of the assets used in distributing content to client devices 125. The network of nodes can be a heterogeneous network of nodes including nodes of different types or corresponding to different types of assets. For example, the plurality of assets represented by the nodes of the network of nodes can include at least one asset of a first entity type and at least one asset of a second entity type different from the first entity type. The database can maintain data structures indicative of the policies and respective labels. Depending on the implementation, the entity type refers to a category type for assets the system 100 analyzes and/or potentially analyzes. For example, entity types may include webpages, customers, media content elements, etc. The system 100 may also categorize the nodes representing assets according to entity types.

The violation detection module 112 can detect violations of policy labels or policies of the data processing server 110, for example, by a third-party content provider, a respective content provider computing device 115, or a respective asset. In some implementations, the policy violation module 112 relies on feedback from client devices 125 and/or other computing devices (e.g., a computing device associated with the data processing server 110) reporting malicious or deceptive behavior and/or behavior otherwise non-conforming with one or more policies associated with a given asset. The malicious, deceptive, or otherwise unacceptable behavior can include, for example, distribution of malware, a sneaky redirect, or cloaking, among other unacceptable practices, by third-party content providers and/or respective assets. A content item, landing page, or other resource from a malicious content source (e.g., a third-party content provider or a respective host or domain) can cause a client device 125 to download malware by accessing and/or attempting to access the content item, landing page, or other resource.

Sneaky redirects occur when landing pages are configured to automatically redirect client devices 125 to other pages, which the client device 125 did not intend to access. For example, a client device 125 can receive a content item from the data processing server 110, including a link for a landing page related to the subject matter of the content item. However, upon interaction with the link, the landing page can redirect the client device 125 to some other page, for example, associated with offensive or inappropriate sexual content.

Cloaking refers to the practice of presenting different content or URLs to client devices 125 and computing devices associated with a content distribution system (e.g., the data processing server 110 or search engines). A host, website, or webpage of a rogue content source can include executable instructions to check whether an IP address of a given computing device is associated with a client device 125 or a content distribution system, and determine which content or URL to provide to the computing device based on the result of the check. As such, the host, website, or webpage can present to client devices 125 different content than what is declared to the data processing server 110.

In some implementations, testing personnel associated with the data processing server 110 test various assets for any practices or activities associated with policy labels or policies of the data processing server 110, and report any relevant policy labels or violations to the violation detection module 112. In further implementations, the violation detection module 112 can detect relevant policy labels (e.g., policy labels that apply to a given asset) automatically. For example, the violation detection module 112 can check whether websites and/or landing pages associated with content providers include malware. The violation detection module can then identify the set of attributes corresponding to instructions to perform sneaky redirects or check IP address to perform cloaking. An asset that includes such software instructions is capable of violating the policies of the data processing server 110 even if it only attempted to perform and/or did not yet perform sneaky redirects or cloaking. In some implementations, upon detecting a policy label associated with a given asset, the violation detection module 112 provides an indication of said asset or feature of said asset to the node aggregation module 114 or to the label classifier module 116.

The node aggregation module 114 can identify a node, referred to herein as a seed node, in a network of nodes associated with the asset having (or mapped to) the policy label (e.g., involved in or capable of policy violation). The identified node (or seed node) can be the node representing the asset identified to be associated with the policy label or another node, for example, corresponding to an asset of a given type that is related to the asset identified as associated with the policy label. Further, the seed node is associated with one or more aggregator nodes that aggregate information related to a particular attribute, feature, entity type, or other such category. For example, the seed node may be associated with a customer aggregator node and a website (or site) aggregator node that aggregate information related to features of customers visiting a website and features of the website, respectfully. The aggregator node aggregates and consolidates hidden states (i.e., inputs at a given step in time for the network node) from a number of sources within a local neighborhood of the aggregator node.

In some implementations, hidden state information gathered by the aggregator node is information relevant to the seed node and/or the asset that the seed node represents. For example, the hidden state information may include information such as website domains that link to the asset, website domains that the asset links to, public cookies and/or cookie information from a user accessing the asset, etc.

The node aggregation module 114 can cause an aggregator node to aggregate information related to a particularly entity type. Specifically, the aggregation module 114 can configure an aggregator node to aggregate data for entities of a predefined type and can start the aggregation process for each aggregator node to aggregate data from each node in the overall network having information related to and/or of a predefined entity type. For example, the aggregation module 114 may configure a first aggregator node to aggregate data on a website from each node corresponding to a customer device. Notably, however, traversing all nodes of a large network of nodes can be computationally inefficient and can induce latency with regard to the analysis of a seed node. As such, each aggregation node may limit aggregation to a local neighborhood for the aggregation node and/or of a particular entity type so as to reduce processing runtime and improve computational efficiency.

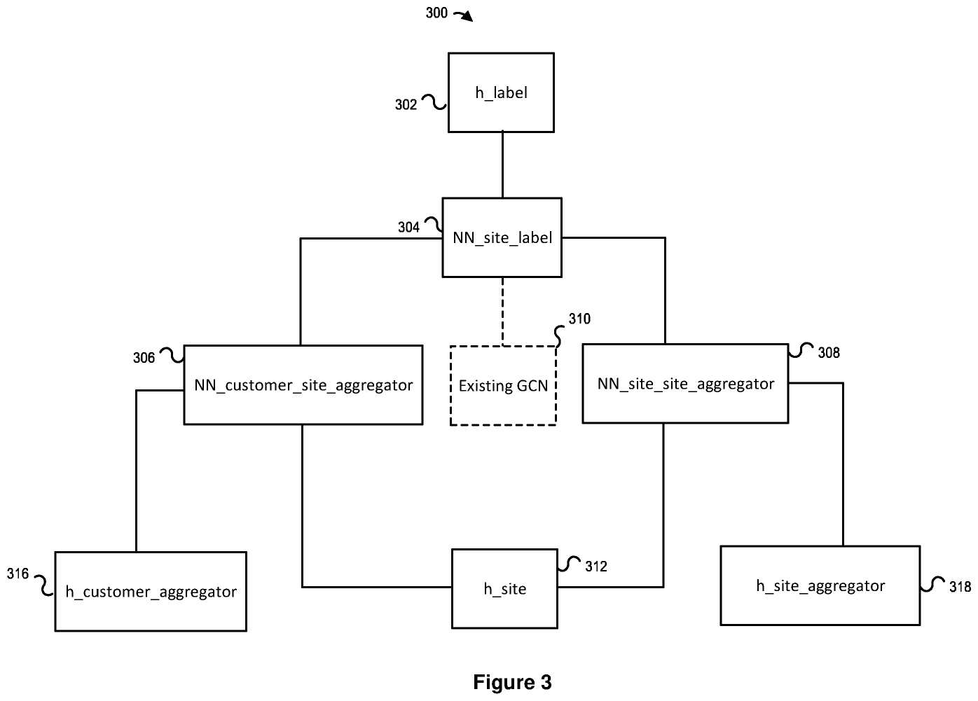

In some implementations, a local neighborhood is a neighborhood of nodes no more than two hops (i.e. one intermediate node) away from the aggregator node. In other implementations, a local neighborhood is a neighborhood of nodes no more than three, four, or five hops away from the aggregator node. In further implementations, a user determines the size of the local neighborhood for the node aggregation module. As the complexity of a neural network greatly increases with the number of hops, a user may prefer to choose a smaller size for the local neighborhood where possible. In still further implementations, the size of a local neighborhood and/or a distant neighborhood may be determined based on a convolutional window in which the system performs a convolutional analysis as described in more detail below with regard to FIGS. 3-5. A local neighborhood may be any node within the convolutional window, while a distant neighborhood may be any node outside the convolutional window.

Each asset can have a respective identifier associated with the entity type (also referred to as entity identifiers) and each node in a network of nodes can include (e.g., as metadata or as an identifier of the node itself) an identifier of the corresponding asset. In some implementations, the node aggregation module 114 searches a network of nodes for any nodes having the identifier associated with a respective entity type. In such implementations, the node aggregation module 114 then causes the respective aggregator node to begin gathering data from the nodes including the identifier associated with the relevant entity type. In some implementations, the database 118 includes a data structure that maps entity identifiers to identifiers of corresponding nodes in the network of nodes. The node aggregation module 114 can use the data structure to locate nodes corresponding to the relevant entity type. In other implementations, once the node aggregation module 114 identifies a node with the relevant entity type, the related aggregator node may use links and/or edges connected to that node to identify other nodes corresponding to the entity type in question.

In some implementations, the node aggregation module 114 identifies a set and/or combination of two or more attributes of the seed node (or corresponding asset) identified to be directly associated with the policy label. The node aggregation module 114 can identify the set of attributes for use to identify other assets and corresponding nodes that belong to the same owner or content source as the asset (or corresponding seed node) identified to be directly associated with the policy label. For example, the fact that two domains are connected either to the same content provider account, the same IP address, or the same resource does not necessarily imply that they belong to the same content source (or the actor behind the activity or behavior associated with the policy label). In some implementations, however, when a group of domains (or other assets), or corresponding nodes, shares a combination of two or more independent attributes, the domains (or other assets) are determined to be created, provided, or used by the same content source. In some such implementations, the node aggregation module 114 can create, identify, and/or designate an aggregator node for each attribute and/or each set of attributes to identify similar nodes for aggregation. In further implementations, the node aggregation module 114 uses the attributes as entity types and aggregates information based on the attributes.

The node aggregation module 114 can identify the set of attributes using information or data from the network of nodes. In particular, the node aggregation module 114 can identify the set of attributes based on edges, links, or immediate neighboring nodes of the seed node and/or the aggregator nodes. The node aggregation module 114 can identify the attributes using neighboring nodes within a local neighborhood of the seed node and/or the aggregator nodes. Further, the node aggregation module 114 can identify the attributes using metadata, if any, associated with the seed node. For example, the attributes for a website domain can include the content provider account, the payment information, the landing pages, the data files, or any combination thereof, associated with that website domain. The attributes for a content provide account can include the website domain, the payment information, the landing pages, the data files, or any combination thereof, associated with that content provide account. The node aggregation module 114 can further identify the attributes based on a set of predefined attribute types.

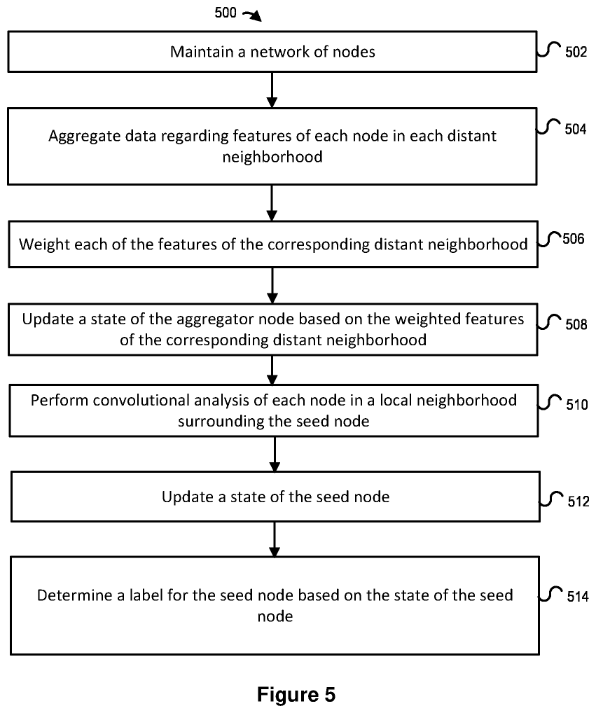

In some implementations, the node aggregation module 114 causes the aggregator nodes to aggregate the data based on a personalized page ranking for the asset. A personalized page ranking is a rank of assets based on characteristics such as the number of links, the frequency of links, and the quality of assets linked to from the asset being analyzed. Depending on the implementation, node aggregation module 114 and/or another component of the system 100 determines the personalized page ranking using a page ranking algorithm based on or related to the subject, as described in more detail with regard to FIG. 5 below.

In some implementations, the node aggregation module 114 causes the aggregator nodes to aggregate the data by generating a vector for the corresponding entity type according to the following equation: Σᵢrᵢf_{T}(xᵢ), wherein rᵢ is a personalized page ranking with starting node i to the seed node that is being analyzed/classified, xᵢ is a feature of node i, and f_{T} is a learnt embedding neural network specific to entity type T. Depending on the implementation, the node aggregation module 114 restricts the number of nodes analyzed by each aggregator node to a predetermined or user-set number of nodes k. The nodes may be the top k nodes according to personalized page ranking. Further, in some implementations, the node aggregation module 114 assigns a weight to each of the features and/or attributes of the nodes. In further implementations, the node aggregation module 114 assigns weights according to an influence function describing the effects of a node y on another node x. For example, the influence of a node x on another node y may be represented by the equation

$$I ( x , y ) = {\sum }_{i} {\sum }_{j} \frac{\partial {y}_{j}}{\partial {x}_{i}} ,$$

wherein y is an aggregator node and x is any node in a neighborhood of nodes surrounding the aggregator node. In still further implementations, the system 100 may additionally or alternatively assign weights based on a personalized page ranking as described with regard to FIG. 5 in more detail below. In still further implementations, the system 100 may perform a learnt projection to a common embedding space—i.e., the aggregator node. The system 100 then creates an aggregated vector of the aggregated weights via a sum weighted by the personalized page ranking to a source node, such as the seed node or the aggregator nodes.

The node aggregation module 114 can then update and/or cause an aggregator node to update the hidden state of the aggregator node in question. In the various implementations outlined above, the node aggregation module 114 may update the hidden state based on the weighting of the various attributes and/or features of the nodes from which the aggregation nodes aggregate data. Depending on the implementation, the node aggregation module 114 can discard attributes and/or features with a weight below a predetermined threshold. In some implementations, the node aggregation module 114 updates the state of the aggregator node by generating a vector for each aggregator node as described in more detail with regard to FIG. 5 below.

In some implementations, the node aggregation module 114 considers only the k nodes with the strongest relation and/or relevance to the seed node. In further implementations, a user selects a value for k. In further implementations, the node aggregation module 114 selects a value for k based on a predetermined value or based on the size of the neural network. In still further implementations, the node aggregation module 114 selects a value for k but a user may override and/or change the value.

The label classifier module 116 can store, in one or more data structures, an association between the seed node and a tag based on the first asset identified to be directly associated with the policy label of the policy of the content distribution system. The label classifier module 116 can use the tag to categorize a first set of assets of the plurality of assets corresponding to the network of nodes. For example, the label classifier module 116 can use the tag to categorize the asset corresponding with the seed node as rogue, malicious, suspicious, or blocked, among other categorizations. In further implementations, the label classifier module 116 can further use the tag to similarly categorize assets associated with the aggregator nodes or other nodes in the network of nodes. In still further implementations, the label classifier module 116 prevents or restricts provisioning of (or providing) one or more assets, such as data files, landing pages, or content items of the tagged asset(s) to client devices 115.

FIG. 1B depicts a block diagram of the architecture of a computer system 150 upon which one or more network nodes may operate. The computer system 150 includes a communications interface 155 which is communicatively connected to an output device 152, an input device 154, a processor 156, and a memory 158. The computer system 150 is further connected to the network 105 through the communications interface 155. In some implementations, the network 105 is the same network as the network 105 of FIG. 1A.

Computer system 150 may be employed to implement any of the computer systems and/or servers discussed herein, including the server 110 and its components such as the violation detection module 112, node aggregation module 114, and label classification module 116, in accordance with some implementations. The computer system 150 can provide information via the network 105 for display. In some implementations, the computer system 150 comprises one or more processors 156 communicatively coupled to memory 158, one or more communications interfaces 155, one or more output devices 152 (e.g., one or more display units), and one or more input devices 154. In some implementations, the processors 156 are included in the data processing server 110 and/or the other components of the server 110, such as the violation detection module 112, node aggregation module 114, and label classification module 116.

In the computer system 150, the memory 158 may comprise any computer-readable storage media, and may store computer instructions such as processor-executable instructions for implementing the various functionalities described herein for respective systems, as well as any data relating to such, generated by such, or received via the communications interface(s) or input device(s) (if present). In some implementations, the data processing server 110 as described with regard to FIG. 1A above includes the memory 158 to store data structures and/or information related to, for example, the network of nodes. In some such implementations, the memory 158 includes the database 145. The processor(s) 156 may execute instructions stored in the memory 158 and, in so doing, may also read from and/or write to the memory various information processed and/or generated pursuant to execution of the instructions.

The processor(s) 156 of the computer system 150 also may be communicatively coupled to and/or control the communications interface(s) 155 to transmit and/or receive various information pursuant to execution of instructions. For example, the communications interface(s) 155 may be coupled to a wired or wireless network, bus, and/or other communication means, and may therefore allow the computer system 150 to transmit information to and/or receive information from other devices (e.g., other computer systems). Moreover, one or more communication interfaces facilitate information flow between the components of the system 150. In some implementations, the communications interface(s) may be configured (e.g., via various hardware and/or software components) to provide a website to at least some aspects of the computer system 150 as an access portal. Examples of communication interfaces 155 include user interfaces (e.g., web pages), through which the user can communication with the data processing server 110.

The output devices 152 of the computer system 150 may be provided, for example, to allow a user to view and/or otherwise perceive various information in connection with the execution of the instructions. The input device(s) 154 may be provided, for example, to allow a user to make manual adjustments, make selections, enter data, and/or interact in any of a variety of manners with the processor during execution of the instructions. Additional information relating to a general computer system architecture that may be employed for various systems discussed herein is provided further herein.

The computing system 150 can include client devices 115, content provide computing devices 120, content publisher computing devices 125, and/or servers or computing devices of the data processing server 110. For example, the data processing server 110 can include one or more servers in one or more data centers or server farms. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

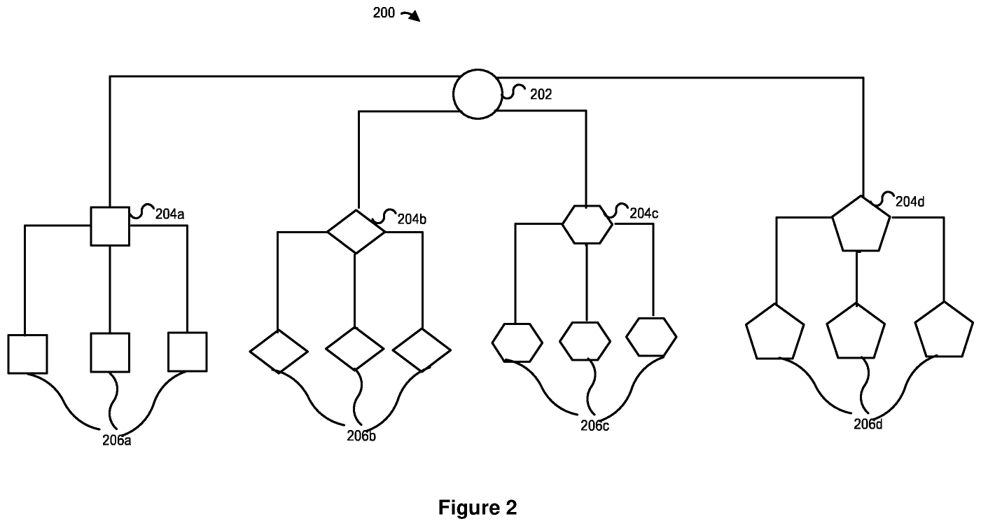

FIG. 2 illustrates an example network of nodes 200 including local node neighborhoods, aggregator nodes, and a seed node, which may be implemented in the system and device of FIGS. 1A-1B. Network 200 is a neural network of nodes, including at least a seed node 202, multiple aggregator nodes 204a-d, and distant neighborhoods of nodes 206a-d.

In some implementations, each node in the network 200 represents an asset that corresponds with a content source, such as a website, domain, media element, etc. In such implementations, the seed node 202 is the node that the system 100 analyzes and labels. Each aggregator node 204a-d exists in a local neighborhood around the seed node. In some implementations, the aggregator nodes 204a-d are facets of and/or reflect facets of seed node 202. Put another way, the aggregator nodes 204a-d reflect and include particular characteristics, attributes, and/or features of the seed node 202. In other implementations, the aggregator nodes 204a-d only aggregate information from distant neighborhoods 206a-d. In such implementations, information for weighting the nodes of the distant neighborhoods 206a-d may be in regard to the seed node 202 rather than in regard to the aggregator nodes 204a-d, as explained in more detail below with regard to FIG. 5.

Each node of the network 202 connects to other nodes by way of one or more edges. Though FIG. 2 illustrates a strict hierarchy from the seed node 202 to the aggregator nodes 204a-d, and further from the aggregator nodes 204a-d to the nodes in the distant neighborhoods 206a-d, this is for clarity of illustration purposes. The actual network 200 may include a greater number of interconnections between nodes. For example, each of the nodes in the distant neighborhoods 206a-d may be further connected to the seed node 202 or indirectly connected via intermediate nodes, and the system 100 may use the edges between the nodes in question for weighting and/or calculating a personalized page ranking as described with regard to FIG. 5 below. The edges illustrated in FIG. 2 instead illustrate the connection along which the overall analysis is performed. For example, each aggregator node 204a-d weights features of nodes in distant neighborhoods 206a-d and aggregates data regarding the weighted features before passing a message to the seed node 202 as part of a convolutional analysis.

FIG. 3 illustrates a block diagram of an example neural network 300, implementing the hybrid MPNN-PPR graph convolution techniques to label a seed node. The example neural network 300 includes a number of neural network blocks and hidden states. Each block labelled as “h_x” represents a hidden state and each block labelled “NN_x” represents a neural network block. As such, each of blocks 302, 310, 312, and 314 are hidden state blocks, and each of blocks 304, 306, and 308 are neural network blocks to which the hidden states correspond. In some implementations, each hidden state block represents one or more features of the relevant node, such as customer data, site data, label data, etc.

Hidden state block 302 is a hidden block regarding the label characteristic for a given site. In some implementations, the label is a designation as to whether a site is malicious and/or contains malicious data, such as viruses or malware. In further implementations, the label is a designation as to whether a site corresponds to and/or links to a known malicious site. Hidden state block 302 corresponds with and defines a feature of neural network block 304, which is a node representing the actual site. As shown in FIG. 3 by the connecting edge between the hidden state block 302 and the neural network block 304, neural network block 304 updates the hidden state block 302 with information from various aggregator nodes in the network.

Each of neural network block 306 and neural network block 308 functions as an aggregator node for the neural network block 304. For example, neural network block 306 is a neural network block that aggregates information relevant to a site label and related to the customer (e.g., past sites visited, links followed to reach the site, error reports and/or messages related to the site from a customer device, etc.) via hidden state block 310. Similarly, neural network block 308 is a neural network block that aggregates information relevant to a site label and related to the site (e.g., linked sites, information related to displayed ads on the site, etc.) via hidden state block 314. Further, each of the neural network blocks 306 and 308 aggregates more general information related to the site via hidden state block 312. In some implementations, the neural network block 304 related to the site label functions as a seed node, and each of the neural network blocks 306 and 308 function as aggregator nodes connected to the seed node.

After aggregating relevant information from the associated hidden state blocks 310, 312, and 314, each of neural network blocks 306 and 308 pass the information to neural network block 304. In some implementations, the neural network block 304 forms a message passing neural network (MPNN) with each of the aggregator blocks, such as neural network blocks 306 and 308, within a local neighborhood of the aggregator blocks and receives messages from each aggregator block within the local neighborhood. In some such implementations, each aggregator block within the local neighborhood passes at least one message to the neural network block 304 before the neural network block 304 updates the hidden state 302 of the label for the site. In further implementations, the neural network block 304 also receives messages and/or information from an otherwise existing neural network, such as a graph convolutional network (GCN) 310. Depending on the implementation, the neural network block 304 may pull information from a local neighborhood larger than a single hop (i.e., edge) away from the neural network block 304. For example, the neural network blocks 306 and 308 may aggregate information from other aggregator nodes (not shown), and the neural network block 304 may receive messages from the other aggregator nodes two hops away, three hops away, or any number as determined by the user and/or by the data processing server maintaining the neural network 300. In implementations in which the neural network block 304 receives messages from an existing GCN 310, the neural network block 304 may receive information from blocks more than three hops away by a convolutional process performed by a seed node of the existing GCN 310.

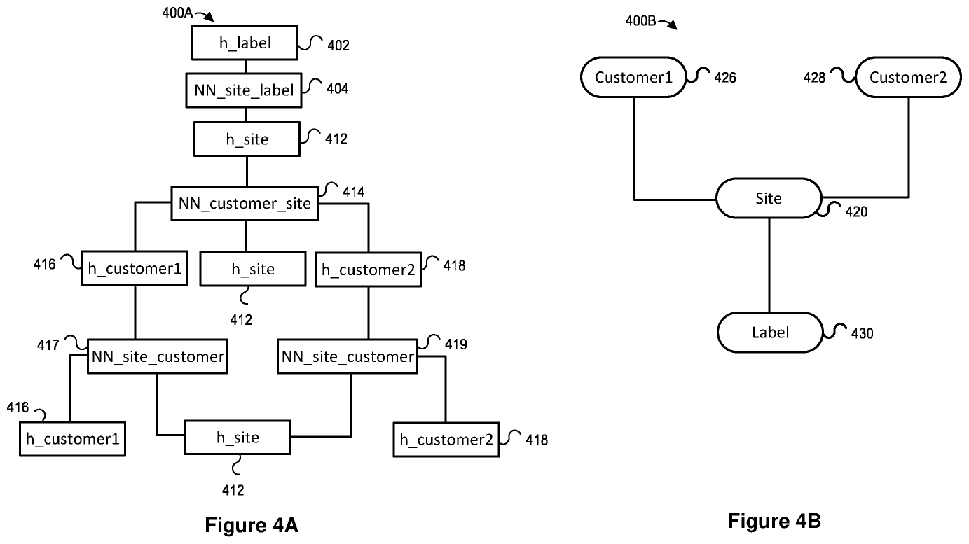

FIGS. 4A and 4B illustrate a block diagram of an example traditional neural network 400A implementing an example message passing schedule 400B to label a seed node.

Much like the neural network 300 that implements the hybrid MPNN-PPR techniques described herein, a traditional MPNN neural network 400A updates the label hidden state block 402 via a neural network block 404 receiving information on the site in question. Unlike the neural network 300, however, the neural network block 404 does not receive messages directly from a series of aggregator blocks, but rather updates the label hidden state block 402 using the hidden state 412 of the site in question, which is individually updated by a neural network customer site block. For a message passing schedule 400B with multiple customers (e.g., customer1 426 and customer2 428) passing messages to the site 420 and onward to the label 430, the hidden state 412 of the site may need to be updated multiple times. For example, in the example neural network of 400A, the hidden state 412 of the site is updated twice for the two customers. In particular, a neural network block 417 pulling information on the site and customer1 as well as a neural network block 419 pulling information on the site and customer2 update the hidden states 416 and 418 of the customer1 and customer 2 blocks, respectively, causing an update to the hidden state 412 of the site each time.

Each neural network block 417 and 419 retrieves data regarding the hidden state of the associated customer (customer1 from hidden state block 416 for neural network block 417 and customer2 from hidden state block 418 for neural network block 419) as well as from the hidden state 412 of the site and updates the corresponding hidden state 416 and 418, respectively. The neural network block 414 then updates the hidden state 412 of the site using the previous hidden state data 412 for the site as well as the updated hidden state for the customer1 416 and the updated hidden state for the customer2 418.

Comparing the hybrid MPNN-PPR neural network 300 to the traditional MPNN neural network 400A illustrates the improvements to network traffic and functionality of the data processing server maintaining the neural networks 300 and/or 400A. For example, each of the neural network blocks 306 and 308 pass a single message to the seed node and neural network block 304 after aggregating hidden state information related to the customers and the website at blocks 316 and 318, respectively. Further, the neural network 300 has no recursive blocks, instead including a single neural network block 304 to update the label and a single neural network block each for the customer (e.g., neural network block 306) and the site (e.g., neural network block 308).

As such, the number of resources needed to manage the neural network 300 is reduced compared to the traditional neural network 400A. Similarly, the resources needed to maintain the message passing in the neural network 300 is reduced for even simple message passing schedules such as 400B. In particular, neural network passes two messages to the neural network block 304 (e.g., one each from neural network blocks 306 and 308) compared to the four passed to the neural network block 404 (e.g., one each from the neural network blocks 417 and 419 to the neural network block 414 and two from the neural network block 414 to the neural network block 404). As the neural network 300 adds more aggregator nodes based on the number of types of entities rather than the number of actual entities, as neural network 400A functions, the reduction of number of messages passed will be better improved with the number of entities being analyzed. For sufficiently complex neural networks, the techniques to implement neural network 300 avoids over-smoothing, where node embeddings look the same to a network due to the number of nodes being analyzed.

Moreover, a data processing system maintaining the neural network 300 has improved runtimes and operation speeds compared to a data processing system maintaining the neural network 400A. By reducing the required redundancy and the number of neural network blocks, the data processing system is able to perform an analysis on a seed node to determine a label status faster than using traditional techniques. As such, implementing a hybrid MPNN-PPR neural network structure over a traditional MPNN structure improves the operations of the data processing server and/or other computing devices maintaining the neural network in question.

Moreover, adding information from distant neighborhoods of nodes to an analysis of the seed node improves performance. In particular, an area under a precision-recall curve (AUPRC) metric of the method may represent an improvement over other techniques. In some implementations, application of the present techniques may increase AUPRC by at least 10% (e.g., from 60% to 70%) over conventional MPNN systems. In other implementations, the AUPRC of the instant techniques is at least 95%. Put another way, analysis using the hybrid structure of neural network as described herein may correctly identify more than 95% of all positive instances of a label being applied (e.g., detecting a malicious download or other policy violation).

Referring next to FIG. 5, a method 500 can be implemented in a neural network of nodes 200 implemented in a system such as system 100 having a data processing server 110 that includes a violation detection module 112, a node aggregation module 114, a label classifier module 116, and a database 118. Though method 500 is described below with regard to the neural network of nodes 200 and the system 100, the method 500 may be implemented in any similar neural network of nodes and/or system.

At block 502, the system 100 maintains a network of nodes. In some implementations, the network of nodes is a network of nodes similar to network 200 as illustrated in FIG. 2. The network of nodes includes multiple nodes and edges connecting pairs of nodes. Each node in the network represents an asset that corresponds with a content source. For example, a particular node may represent an asset such as a third-party content item, a landing page, a resource, or any other similar asset that may be associated with a content policy. Similarly, the nodes in the network may represent assets for the same content source, for different content sources related to the content source (i.e., content sources directly linked from the initial content source), or for content sources distantly related to the content source (i.e., content sources a number of hops away from the initial content source).

At block 504, the system 100 begins aggregating data regarding features of each node in each distant neighborhood. In some implementations, the system 100 aggregates the data via one or more aggregator nodes 204a-d, each aggregator node associated with one of the distant neighborhoods. In further implementations, each aggregator node 204a-d is associated with a particular asset or entity type. In such implementations, each aggregator node generates a vector for the corresponding entity type according to the following equation: Σᵢrᵢf_{T}(xᵢ), wherein rᵢ is a personalized page ranking with starting node i to the seed node that is being analyzed/classified, xᵢ is a feature of node i, and f_{T} is a learnt embedding neural network specific to entity type T. Depending on the implementation, the system 100 restricts the number nodes analyzed by each aggregator node to a predetermined or user-set number of nodes k. The nodes may be the top k nodes according to personalized page ranking.

At block 506, the system 100 assigns a weight to each of the features of the nodes in a corresponding distant neighborhood for each aggregator node. In some implementations, the system 100 may assign weights simultaneously or substantially simultaneously (i.e., appearing simultaneous to a human observer). For example, the system 100 may transmit a message to each of the aggregator nodes with a schedule indicating a time at which the nodes are to assign weights to features. In other implementations, the system 100 may assign weights at separate times or in real-time as nodes are added to the neural network and/or as features of the nodes change. In some implementations, the system 100 assigns weights according to an influence function describing the effects of a node y on another node x. For example, the influence of a node s on another node y may be represented by the equation

$$I ( x , y ) = {\sum }_{i} {\sum }_{j} \frac{\partial {y}_{j}}{\partial {x}_{i}} ,$$

wherein y is an aggregator node and x is any node in a neighborhood of nodes surrounding the aggregator node.

In further implementations, the system 100 may additionally or alternatively assign weights based on a personalized page ranking—and, as such, the relevance—for a node in the neighborhood. In some such implementations, the system 100 determines the personalized page ranking for a node using a push flow method, such as a forward push method. As such, the source node (such as the aggregator node) pushes probability mass along edges to the target node (such as a neighborhood node). Therefore, the system 100 determines the personalized page ranking for the target node on the source node. In such implementations, the personalized page ranking is therefore an approximation of personalized page ranking and is not specialized based on the edge type. In other implementations, the system 100 determines the personalized page ranking for a node using a reverse push method by starting at each target node and pushing values backwards along edges to the source node.

In still further implementations, the system 100 may perform a learnt projection to a common embedding space (e.g., the aggregator node). The system 100 then creates an aggregated vector of the aggregated weights via a sum weighted by the personalized page ranking to a source node. In some implementations, the source node is the aggregator node. In further implementations, the node being analyzed (e.g., the seed node) functions as the source node for purposes of calculating personalized page ranking, and the aggregator node instead aggregates features related to particular entities for the seed node. As such, the aggregator node may function as an extension of the seed node for particular entity types.

At block 508, the system 100 updates a state of the aggregator node based on the weighted features of the corresponding distant neighborhood. In some implementations, the system 100 updates the state of the aggregator node by generating a vector for each aggregator node. Depending on the implementation, the aggregator node may represent one particular entity type. As such, the system 100 may perform entity specific embedding for distant nodes. In such implementations, the seed node of system 100 learns a different projection for each entity type. As such, the neural network 200 learns the relevant features and/or attributes from each entity type. Therefore, the number of weights scales with the number of types of entities rather than the number of entities. In some implementations, each entity type is represented by a separate aggregator node that collects and aggregates the signals from each distant node in a neighborhood. In some implementations, the aggregated vector for each entity type T is Σᵢrᵢf_{T}(xᵢ), where rᵢ is the personalized page ranking with starting node i to the seed node or aggregator node, xᵢ is the features of node i, and f_{T} is a learnt embedding specific to entity type T.

In some implementations, the sum is over all nodes in the graph of entity type T. In other implementations, the system 100 restricts the number of nodes to the top k nodes in terms of personalized page ranking. As such, the system 100 considers only the nodes with the strongest relation and/or relevance to the seed node. In some implementations, a user selects a value for k. In further implementations, the system 100 selects a value for k based on a predetermined value or based on the size of the neural network. In still further implementations, the system 100 selects a value for k but a user may override and/or change the value.

At block 510, the system 100 performs a convolutional analysis of each node in a local neighborhood surrounding the seed node. In some implementations, the convolutional analysis or convolution is according to a message passing neural network (MPNN) system. In such implementations, each aggregator node passes one or more messages to the seed node. For purposes of scalability and/or computation speed, in some implementations each aggregator node is limited to passing a single message. In further implementations, the aggregator node is limited to passing a single message, but may pass additional messages in response to a notification from the seed node and/or other elements of the system 100 to perform an update after labelling the seed node.

At block 512, the system 100 updates a state of the seed node. In some implementations, the system 100 updates the state of the seed node by collecting messages from and/or performing a convolutional analysis on the aggregator nodes. As such, the system 100 may update the state of the seed node with a single vector, matrix, eigenvector, etc. representing the analyzed data from the aggregator nodes.

At block 514, the system 100 determines a label for the seed node based on the state of the seed node. In some implementations, the label is a designation as to how safe a seed node (such as a content source, website, media element, etc.) is. For example, the label may designate a seed node as being unsafe or malicious due to the number or weight of malicious features and/or elements associated with other nodes in the graph. In further implementations, the label is a designation as to the features associated with the seed node, a type for the seed node, an ownership or relation of the seed node, or any other similar label used in the art.

The following list of examples reflects a variety of the embodiments explicitly contemplated by the present disclosure:

Example 1. A method for classifying assets by features of individual entities and relations of the individual entities to the assets using a neural network configured to maintain a network of nodes including a plurality of nodes and edges, each node of the plurality of nodes representing a respective asset of a plurality of assets corresponding to a plurality of content sources, the method comprising: aggregating, by the one or more processors and at each of a plurality of aggregator nodes in the network of nodes, data regarding features of each node in each distant neighborhood of a multiplicity of distant neighborhoods, wherein each distant neighborhood corresponds with an aggregator node of the plurality of aggregator nodes, a neighborhood is a subset of nodes surrounding the aggregator node within a predefined distance, and a distant neighborhood is a neighborhood of nodes separated from a seed node of the plurality of nodes by at least two intermediate nodes; updating, by the one or more processors and at each of the plurality of aggregator nodes, a state of the aggregator node by assigning a weight to each of the features of the corresponding distant neighborhood; updating, by the one or more processors and at the seed node, a state of the seed node by performing convolutional analysis of each node in a local neighborhood surrounding the seed node, the local neighborhood including each of the plurality of aggregator nodes; and determining, by the one or more processors, a label of the seed node based on the state of the seed node.

Example 2. The method of example 1, wherein assigning the weight is in accordance with an influence function proportional to a personalized page ranking from a first node to a second node.

Example 3. The method of example 2, wherein the influence function is

$$I ( x , y ) = {\sum }_{i} {\sum }_{j} \frac{\partial {y}_{j}}{\partial {x}_{i}} ,$$

wherein x is a first node in the distant neighborhood, each xᵢ is a feature of node x, y is a second node in the distant neighborhood, and each yⱼ is a feature of node y.

Example 4. The method of example 3, wherein y is an aggregator node of the aggregator nodes.

Example 5. The method of any of the preceding examples, wherein each node of each distant neighborhood is outside of a convolutional window around the seed node.

Example 6. The method of any of the preceding examples, wherein each node of each distant neighborhood is no more than a predetermined number of hops away from the corresponding aggregator node.

Example 7. The method of any of the preceding examples, further comprising restricting provisioning of one or more assets.

Example 8. The method of any of the preceding examples, further comprising identifying a combination of two or more attributes of the seed node.

Example 9. The method of example 8, wherein the state of the seed node is based on the combination of two or more attributes of the seed node.

Example 10. The method of any of the preceding examples, wherein each node of each of the distant neighborhoods shares an entity type with the corresponding aggregator node, and wherein each aggregator node has a different entity type.

Example 11. The method of example 10, wherein the seed node learns a different projection for each different entity type.

Example 12. The method of example 10 or 11, wherein the number of weights scales with the number of different entity types.

Example 13. The method of any of examples 10-12, wherein a vector for an entity type is defined as Σᵢrᵢf_{T}(xᵢ), wherein rᵢ is a personalized page ranking with starting node i to a respective aggregator node corresponding to a distant neighborhood, each xᵢ is a feature of the features of node i, and f_{T} is a learnt neural network embedding specific to entity type T.

Example 14. The method of example 13, wherein the vector is a sum over a subset of nodes, and wherein the subset of nodes are nodes of entity type T with personalized page rankings above a predetermined threshold.

Example 15. The method of example 13 or 14, wherein the personalized page rankings are computed using a push flow method.

Example 16. The method of any of the preceding examples, wherein the plurality of assets includes at least one asset of a first type and at least one asset of a second type, the state of the aggregator node is indicative of whether the aggregator node represents an asset of the first type or of the second type, and the state of the seed node is indicative of whether the seed node represents an asset of the first type or of the second type.

Example 17. The method of any of the preceding examples, further comprising passing at least one message from each of the aggregator nodes to the seed node before determining a label of the seed node.

Example 18. The method of any of the preceding examples, wherein an area under a precision-recall curve (AUPRC) metric of the method is at least 95%.

Example 19.A system for classifying assets by features of individual entities and by relations of the individual entities to the assets, using a neural network configured to maintain a network of nodes including a plurality of nodes and edges, each node of the plurality of nodes representing a respective asset of a plurality of assets corresponding to a plurality of content sources, the system comprising: at least one processor; and a memory storing computer-executable instructions that, when executed by the at least one processor, cause the at least one processor to: aggregate, at each of a plurality of aggregator nodes in the network of nodes, data regarding features of each node in each distant neighborhood of a multiplicity of distant neighborhoods, wherein each distant neighborhood corresponds with an aggregator node of the plurality of aggregator nodes, a neighborhood is a subset of nodes surrounding an aggregator node within a predefined distance, and a distant neighborhood is a neighborhood of nodes separated from the seed node by at least two intermediate nodes; update, at each of the plurality of aggregator nodes, a state of the aggregator node by assigning a weight to each of the features of the corresponding distant neighborhood; update, at the seed node, a state of the seed node by performing convolutional analysis of each node in a local neighborhood surrounding the seed node, the local neighborhood including each of the plurality of aggregator nodes; and determine a label of the seed node based on the state of the seed node.

Example 20. The system of example 19, wherein assigning the weight is in accordance with an influence function proportional to a personalized page ranking from a first node to a second node.

Example 21. The system 20, wherein the influence function is

$$I ( x , y ) = {\sum }_{i} {\sum }_{j} \frac{\partial {y}_{j}}{\partial {x}_{i}} ,$$

wherein x is a first node in the distant neighborhood, each xᵢ is a feature of node x, y is a second node in the distant neighborhood, and each yⱼ is a feature of node y.

Example 22. The system of example 21, wherein y is an aggregator node of the aggregator nodes.

Example 23. The system of any of examples 19-22, wherein each node of each distant neighborhood is outside of a convolutional window around the seed node.

Example 24. The system of any of examples 19-23, wherein each node of each distant neighborhood is no more than a predetermined number of hops away from the corresponding aggregator node.

Example 25. The system of any of examples 19-24, wherein the computer-executable instructions, when executed by the at least one processor, further cause the at least one processor to restrict provisioning of one or more assets.

Example 26. The system of any of examples 19-25, wherein the computer-executable instructions, when executed by the at least one processor, further cause the at least one processor to identify a combination of two or more attributes of the seed node.

Example 27. The system of example 26, wherein the state of the seed node is based on the combination of two or more attributes of the seed node.

Example 28. The system of any of examples 19-27, wherein each node of each of the distant neighborhoods shares an entity type with the corresponding aggregator node, and wherein each aggregator node has a different entity type.

Example 29. The system of example 28, wherein the seed node learns a different projection for each different entity type.

Example 30. The system of examples 28 or 29, wherein the number of weights scales with the number of different entity types.

Example 31. The system of any of examples 28-30, wherein a vector for an entity type is defined as Σᵢrᵢf_{T}(xᵢ), wherein rᵢ is a personalized page ranking with starting node i to a respective aggregator node corresponding to a distant neighborhood, each xᵢ is a feature of the features of node i, and f_{T} is a learnt neural network embedding specific to entity type T.

Example 32. The system of example 31, wherein the vector is a sum over a subset of nodes, wherein the subset of nodes are nodes of entity type T with personalized page rankings above a predetermined threshold.

Example 33. The system of example 31 or 32, wherein the personalized page rankings are computed using a push flow method.

Example 34. The system of any of examples 19-33, wherein the plurality of assets includes at least one asset of a first type and at least one asset of a second type, the state of the aggregator node is indicative of whether the aggregator node represents an asset of the first type or of the second type, and the state of the seed node is indicative of whether the seed node represents an asset of the first type or of the second type.

Example 35. The system of any of examples 19-34, wherein the computer-executable instructions, when executed by the at least one processor, further cause the at least one processor to pass at least one message from each of the aggregator nodes to the seed node before determining a label of the seed node.

Example 36. The system of any of examples 19-35, wherein an area under a precision-recall curve (AUPRC) metric of the system is at least 95%.

The following additional considerations apply to the foregoing discussion.

In some implementations, “message” is used and can be replaced by “information element (IE)”. In some implementations, “IE” is used and can be replaced by “field”. In some implementations, “configuration” can be replaced by “configurations” or the configuration parameters.

A user device in which the techniques of this disclosure can be implemented can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IOT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may be software modules (e.g., code, or machine-readable instructions stored on non-transitory machine-readable medium) or hardware modules. A hardware module is a tangible unit capable of performing certain operations and may be configured or arranged in a certain manner. A hardware module can include dedicated circuitry or logic that is permanently configured (e.g., as a special-purpose processor, such as a field programmable gate array (FPGA) or an application-specific integrated circuit (ASIC), a digital signal processor (DSP)) to perform certain operations. A hardware module may also include programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional and alternative structural and functional designs for managing radio bearers through the principles disclosed herein. Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

1. A method for classifying assets by features of individual entities and relations of the individual entities to the assets using a neural network configured to maintain a network of nodes including a plurality of nodes and edges, each node of the plurality of nodes representing a respective asset of a plurality of assets corresponding to a plurality of content sources, the method comprising:
aggregating, by one or more processors and at each of a plurality of aggregator nodes in the network of nodes, data regarding features of each node in each distant neighborhood of a multiplicity of distant neighborhoods, wherein each distant neighborhood corresponds with an aggregator node of the plurality of aggregator nodes, a neighborhood is a subset of nodes surrounding the aggregator node within a predefined distance, and a distant neighborhood is a neighborhood of nodes separated from a seed node of the plurality of nodes by at least two intermediate nodes;
updating, by the one or more processors and at each of the plurality of aggregator nodes, a state of the aggregator node by assigning a weight to each of the features of the corresponding distant neighborhood;
updating, by the one or more processors and at the seed node, a state of the seed node by performing convolutional analysis of each node in a local neighborhood surrounding the seed node, the local neighborhood including each of the plurality of aggregator nodes; and
determining, by the one or more processors, a label of the seed node based on the state of the seed node.

2. The method of claim 1, wherein assigning the weight is in accordance with an influence function proportional to a personalized page ranking from a first node to a second node.

3. The method of claim 2, wherein the influence function is
$$I ( x , y ) = {\sum }_{i} {\sum }_{j} \frac{\partial {y}_{j}}{\partial {x}_{i}} ,$$
wherein x is a first node in the distant neighborhood, each xᵢ is a feature of node x, y is a second node in the distant neighborhood, and each yⱼ is a feature of node y.

4. The method of claim 3, wherein y is an aggregator node of the aggregator nodes.

5. The method of claim 1, wherein each node of each distant neighborhood is outside of a convolutional window around the seed node.

6. The method of claim 1, wherein each node of each distant neighborhood is no more than a predetermined number of hops away from the corresponding aggregator node.

7. The method of claim 1, further comprising identifying a combination of two or more attributes of the seed node; and
wherein the state of the seed node is based on the combination of two or more attributes of the seed node.

8. The method of claim 1, wherein each node of each of the distant neighborhoods shares an entity type with the corresponding aggregator node, and wherein each aggregator node has a different entity type.

9.-10. (canceled)

11. The method of claim 8, wherein a vector for an entity type is defined as Σᵢrᵢf_{T}(xᵢ), wherein rᵢ is a personalized page ranking with starting node i to a respective aggregator node corresponding to a distant neighborhood, each xᵢ is a feature of the features of node i, and f_{T} is a learnt neural network embedding specific to entity type T.

12.-13. (canceled)

14. The method of claim 1, further comprising passing at least one message from each of the aggregator nodes to the seed node before determining a label of the seed node.

15. (canceled)

16. A system for classifying assets by features of individual entities and relations of the individual entities to the assets, the system comprising:
a neural network configured to maintain a network of nodes including a plurality of nodes and edges, each node of the plurality of nodes representing a respective asset of a plurality of assets corresponding to a plurality of content sources;
processing hardware; and
a memory storing computer-executable instructions that, when executed, cause the processing hardware to:
aggregate, at each of a plurality of aggregator nodes in the network of nodes, data regarding features of each node in each distant neighborhood of a multiplicity of distant neighborhoods, wherein each distant neighborhood corresponds with an aggregator node of the plurality of aggregator nodes, a neighborhood is a subset of nodes surrounding the aggregator node within a predefined distance, and a distant neighborhood is a neighborhood of nodes separated from a seed node of the plurality of nodes by at least two intermediate nodes;
update, at each of the plurality of aggregator nodes, a state of the aggregator node by assigning a weight to each of the features of the corresponding distant neighborhood;
update, at the seed node, a state of the seed node by performing convolutional analysis of each node in a local neighborhood surrounding the seed node, the local neighborhood including each of the plurality of aggregator nodes; and
determine a label of the seed node based on the state of the seed node.

17. The system of claim 16, wherein assigning the weight is in accordance with an influence function proportional to a personalized page ranking from a first node to a second node.

18. The system of claim 17, wherein the influence function is
$$I ( x , y ) = {\sum }_{i} {\sum }_{j} \frac{\partial {y}_{j}}{\partial {x}_{i}} ,$$
wherein x is a first node in the distant neighborhood, each xᵢ is a feature of node x, y is a second node in the distant neighborhood, and each yⱼ is a feature of node y.

19. The system of claim 18, wherein y is an aggregator node of the aggregator nodes.

20. The system of claim 16, wherein each node of each distant neighborhood is outside of a convolutional window around the seed node.

21. The system of claim 16, wherein each node of each distant neighborhood is no more than a predetermined number of hops away from the corresponding aggregator node.

22. The system of claim 16, wherein the memory further stores instructions that, when executed, cause the processing hardware to:
identify a combination of two or more attributes of the seed node; and
wherein the state of the seed node is based on the combination of two or more attributes of the seed node.

23. The system of claim 16, wherein each node of each of the distant neighborhoods shares an entity type with the corresponding aggregator node, and wherein each aggregator node has a different entity type.

24. The system of claim 23, wherein a vector for an entity type is defined as Σᵢrᵢf_{T}(xᵢ), wherein rᵢ is a personalized page ranking with starting node i to a respective aggregator node corresponding to a distant neighborhood, each xᵢ is a feature of the features of node i, and f_{T} is a learnt neural network embedding specific to entity type T.

25. The system of claim 16, wherein the memory further stores instructions that, when executed, cause the processing hardware to:
pass at least one message from each of the aggregator nodes to the seed node before determining a label of the seed node.
